(19) United States
(12) Patent Application Publication
(10) Pub. No.: US 2001/0004734 A1
(43) Pub. Date: Jun. 21, 2001

(54) Method, system and program product for managing and ordering supplies for office equipment

(75) Inventors: Takuji Kudoh, Hadano-shi (JP); Atsushi Sakaue, Fujisawa-shi (JP)

Correspondence Address: Floyd A. Gonzalez, IBM Corporation-IPLaw, 2455 South Road - MS P386, Poughkeepsie, NY, 12601, US

(73) Assignee: International Business Machines Corporation, Armonk, NY (US)

(21) Appl. No.: 09/736,867

(22) Filed: Dec. 14, 2000

(30) Foreign Application Priority Data
Dec. 15, 1999 (JP) 11-355396

(51) Int. Cl. G06F 17/60

(52) U.S. Cl. 705/26

(57) ABSTRACT

The present invention provides a process for automatically generating information including a purchase order for a depleted item after sensing that the amount of the item in stock is less than a pre-specified amount. The purchase order is created using a predetermined form and attached to an e-mail. The e-mail carries the purchase order to an approver if needed or, alternatively directly to a supplier. The function is carried out either by the machine that is using the item or by a separate computer in communication with the machine.

### TECHNICAL FIELD OF THE INVENTION

The present invention relates to a method for ordering supplies for office equipment such as a printer, a copying machine or a facsimile apparatus connected to a network and, more particularly, to a method for ordering supplies by e-mail.

### BACKGROUND OF THE INVENTION

There is a wide variety of electronic and mechanical equipment that depletes a resource that must therefor be renewed from time to time. In order to clearly describe the present invention the equipment is described in terms of example office equipment such as a printer, a copying machine or a facsimile apparatus requiring supplies such as toner, ink, an ink ribbon and printing paper. The practice of the invention in other electronic and mechanical equipment is within the scope of the invention.

Some office equipment senses the remainder of the supplies so as to alert an operator by means such as a buzzer or a light before the supplies run out. Otherwise, some office equipment sense the remainder of the supplies, and then, automatically create an order sheet specifying the supplies that are depleted.

In the former case, it has been necessary for an administrator of the office equipment (hereinafter simply referred to as “an administrator”) to confirm information required for ordering as well as the product names and suppliers to be notified, and then, order the supplies. It has been necessary to consult an instruction manual of the office equipment in order to confirm the information required for ordering. This work has been cumbersome for the administrator. In the latter case, since the information specifying the supplies is automatically provided in an order sheet, the administrator is absolved of cumbersome work such as retrieval of an instruction manual, but may be unaware of the printing or outputting of the order sheet. In other words, even if the order sheet is automatically printed or created, the administrator may be late in sending the order sheet to a destination, i.e., a supplier of the supplies.

In order to solve the above-described problems, there has been proposed a system for sensing the remainder of supplies so as to automatically order, by telephone, the supplies which are running out. For example, Published Unexamined Patent Application Nos. 4-151765 and 7-322032 disclose a system for automatically ordering supplies in a facsimile apparatus in which the remainder of the supplies is sensed, an order sheet is created when it is determined that ordering is required, and then, the order sheet is sent to a facsimile apparatus of a supplier.

### SUMMARY OF THE INVENTION

The invention disclosed in Published Unexamined Patent Application Nos. 4-151765 and 7-322032 is the technique for secure ordering of supplies. However, in such an automatic ordering system, an administrator of the facsimile apparatus cannot preview the contents of the order sheet of the supplies. In addition, although each user's company (hereinafter simply referred to as “users”) which uses the facsimile apparatus generally chooses a format of the order sheet for use in ordering the supplies as well as other goods, the system disclosed in Published Unexamined Patent Application Nos. 4-151765 and 7-322032 cannot perform this function. Furthermore, not only the administrator of the facsimile apparatus but also his or her supervisor may need to approve the order in the case where the order sheet is sent to the destined supplier. Such a pre-approval cannot be obtained once the order sheet is automatically sent by the users facsimile apparatus.

Therefore, an object of the present invention is to provide a method for ordering supplies with an option for pre-approval by an administrator.

Moreover, another object of the present invention is to provide a method for ordering supplies without requiring an administrator to create an order sheet in a customized format.

These and other objects will be apparent to one skilled in the art from the following drawings and detailed description of the invention.

### BRIEF DESCRIPTION OF THE DRAWINGS

FIG. 1 is an illustration of the configuration of a print system in a first embodiment;

FIG. 2 is a block diagram illustrating the function of a printer 2 in a first embodiment;

FIG. 3 illustrates an example of a blank order sheet form in a first embodiment;

FIG. 4 illustrates an example of a filled in order sheet in a first embodiment;

FIG. 5 illustrates an example of an e-mail document for transmitting an order in a first embodiment;

FIG. 6 illustrates the definitions of tables used to practice the invention with the printer 2 in a first embodiment;

FIG. 7 is a flowchart illustrating the process of ordering supplies in a first embodiment;

FIG. 8 is a flowchart illustrating the process of delivering the supplies in a first embodiment;

FIG. 9 is a view illustrating the configuration of a print system in a second embodiment;

FIG. 10 is a block diagram illustrating the functions of printers 2a to 2c and print server 6 in a second embodiment;

FIG. 11 is block diagram illustrating an alternative example of the functions of printers 2a to 2c and print server 6 in a second embodiment;

FIG. 12 illustrates an order information master in a second embodiment;

FIG. 13 illustrates an example of an e-mail document for transmitting an order in a second embodiment;

FIG. 14 illustrates a alternate example of an e-mail document for transmitting an order in the second embodiment.

### DESCRIPTION OF THE PREFERRED EMBODIMENT

In order to solve the above-described problems, according to the present invention, attention has been paid to designing and registering a form of an order sheet in advance, thereby resulting in an electronic order sheet including information about the required supplies (including for example, the name of the item, the quantity of items to be ordered etc.). The order, when completed, is attached to an e-mail document as an attached file.

The method for ordering supplies comprises the steps of:

confirming the remainder or inventory of supplies;

comparing a predetermined lower limit value (such that supplies will be ordered if inventory falls below the value), with the remainder (or inventory) of the supplies confirmed in the confirming step;

creating an order sheet in which the name and order quantity of the supplies are filled in if the confirmed remainder (or inventory) of the supplies becomes equal to or less than the predetermined lower limit;

creating an e-mail document for transmitting the order of the supplies, the order sheet being attached as an attached file to the e-mail document;

and transmitting the e-mail document.

In the above-described method for ordering the supplies, the e-mail document with the order sheet attached thereto may be transmitted to the administrator of the office equipment. In this case, the administrator confirms the contents of the order sheet. If he or she judges that the order is necessary, he or she prints the order sheet. Thereafter, for example, he or she may sign the order sheet, before he or she sends the order sheet to a supplier of the supplies by mail or the like. If the supplier can accept an e-mail without a signature of the administrator, the order sheet may be transmitted to the supplier by e-mail via the administrator. Moreover, if the supplier can accept the e-mail without any confirmation or approval of the ordering, the e-mail document with the order sheet attached thereto may be transmitted directly to the supplier (not via the administrator).

According to the present invention, a supplies managing system for office equipment is provided, in which the above-described method for ordering the supplies for office equipment can be achieved. In the supplies managing system having the function of managing ordering of supplies for office equipment in a network system in which a single or a plurality of office equipment are connected to a plurality of computers via a network, the supplies managing system comprises:

a supplies inventory memory for storing therein, per item to be supplied, the remainder or inventory of items to be used in the office equipment;

an order information memory for storing therein a predetermined lower limit value, wherein whenever the supply of items falls below the value, a replenishing order is required;

a form data memory for storing therein form data describing an order sheet for ordering supplies;

and an e-mail address memory for storing therein an e-mail address of a destination to which the order sheet is to be delivered.

In the supplies managing system for the office equipment according to the present invention, the destination to which the order sheet form is delivered may be the administrator of the office equipment. In the case where the administrator of the office equipment uses one of the plurality of computers, the administrator can receive and confirm the order sheet from the computer.

In the supplies managing system for the office equipment according to the present invention, the single or plurality of office equipment may provide the function of managing the ordering of the supplies. Otherwise, the network system may be provided with a managing server for managing the office equipment, wherein the managing server may have the function of managing the ordering of the supplies. Additionally, each of elements of the function of managing the ordering of the supplies may be appropriately assigned to the office equipment and the managing server. In other words, any embodiment can be encompassed by the present invention as long as the function of managing the ordering of the supplies is provided in the network system.

Examples of the office equipment include printing apparatus represented by a printer, a facsimile apparatus, a copying machine or a multifunction combination thereof. According to the present invention, the printing apparatus can be provided with the elements of the function of managing the ordering of the supplies. That is to say, according to the present invention, in the printing apparatus for performing printing on a sheet member based on input data, the printing apparatus comprises:

a supplies sensing unit for sensing the remainder or inventory of items in the printing apparatus;

an order information memory for storing therein order information on an order quantity determined by item for ordering the items;

an order sheet form memory for storing therein a basic form of an order sheet; an order sheet creating unit for creating the order sheet based on the order information from the order information memory and the basic form stored in the order sheet form memory;

and an e-mail document creating unit for attaching the order sheet created in the order sheet creating unit to an e-mail document.

According to the present invention, the “printing apparatus” generally signifies, in a broad sense, a printer, a facsimile apparatus, a copying machine or a multifunction device thereof. The term “printer” is interpreted in a narrow sense.

Since in the printing apparatus according to the present invention, the basic form of the order sheet is previously stored in the order sheet form memory, it is unnecessary for an administrator of the printing apparatus to perform the task of creating the order sheet for ordering the supplies. In addition, since the order sheet is created on the basis of the order information and the order sheet form, and then, is attached to the e-mail document, the administrator of the printing apparatus can pre-approve the ordering of the supplies if the e-mail document is transmitted to the administrator of the printing apparatus. Furthermore, the order sheet can be printed out for an approval for the ordering. Moreover, if a place for an approval signature is provided on the order sheet, the approval signature for the order can be applied.

In the printing apparatus according to the present invention, the order sheet form stored in the order sheet form memory may not be limited to one format, but may be a plurality of formats, because the order sheet form may be different for each of the suppliers. Incidentally, most users have their own personalized order sheet forms. Consequently, the order sheet form memory provides the advantage of storing therein different formats of order sheet forms for each requirement.

The printing apparatus according to the present invention is desirably provided with an e-mail address memory for storing therein the destination of the e-mail document with the order sheet attached thereto. An e-mail address normally signifies an e-mail address of the administrator of the printer.

Consequently, in the printing apparatus according to the present invention, the e-mail document with the order sheet attached thereto can be transmitted to the administrator of the printer, and thus, the administrator can be notified of the necessity of the ordering of the supplies via e-mail. However, the administrator need not perform the ordering immediately after he receives and confirms the e-mail document with the order sheet attached thereto. For example, unless the supplies need be ordered with emergency, the ordering may be postponed until a predetermined timing in view of a budget. An automatic ordering system without any confirmation of the administrator cannot provide postponement of the ordering for various reasons. The above-described matter is one of advantages provided when the e-mail document with the order sheet attached thereto is transmitted to the administrator.

The printing apparatus according to the present invention is more desirably provided with a history manager for storing therein the history of the ordering or delivery of the supplies. Since the inventory of the supplies is varied after the supplies are delivered, information on the inventory sensed by the supplies sensing unit can be updated on the basis of information on the delivery stored in the history manager. Furthermore, in the case where, for example, the supplies cannot be delivered within a standard delivery date after the ordering of the supplies, the history manager may transmit an e-mail document notifying the administrator of the printing apparatus that the supplies cannot be delivered as requested. In other words, the history manager can be concerned in management of the ordering or delivery of the supplies.

The printing apparatus according to the present invention is connected to a network, over which the e-mail document can be transmitted.

In the printing apparatus according to the present invention, the remainder of the supplies signifies the quantity of the supplies remaining in the printing apparatus per se. However, some of the supplies are reduced in quantity; and others need be replaced due to their lifetime limitations. In the latter case, the degree of age or usage indicates the remaining quantity. The inventory of the supplies signifies the quantity of the supplies held in a place other than the printing apparatus. Since the printing apparatus according to the present invention is provided with the supplies sensing unit for sensing the remainder or inventory of the supplies, the inventory of the supplies in the supplies sensing unit signifies the quantity of the supplies remaining in the printing apparatus per se or the quantity of the supplies held in a place other than the printing apparatus. Of course, it is to be understood that the supplies sensing unit according to the present invention might sense both the remainder and the inventory.

The printing apparatus according to the present invention desirably comprises a supplies memory for storing therein the consumption frequency of each of the items of supply, thereby comparing the consumption frequency of each of the items with the remainder or inventory of the supplies in the supplies sensing unit so as to predict a time when the supplies will run out. If the predicted timing is reflected on the e-mail, the administrator who has recognized the timing can use it for the management of an ordering timing.

Although the description has been given above of the case where the present invention has been embodied in the printing apparatus, the present invention cannot be limited thereto. For example, the present invention can be applied to a print server for managing a printing apparatus shared by clients in a network such as an LAN (a Local Area Network). That is, according to the present invention, in the print server for managing printers shared by clients over a network, the print server comprises:

an order information memory for storing therein order information including an order quantity determined per item and a unit price of each of item in ordering the supplies;

an order sheet form memory for storing therein an order sheet form having a region where the order information is to be provided;

an order sheet creating unit for taking the order information from the order information memory into the region of the order sheet form so as to make an order sheet;

an e-mail document creating unit for attaching the order sheet created in the order sheet creating unit to an e-mail document;

and an e-mail address memory for storing therein a destination of the e-mail document created in the e-mail document creating unit.

The print server according to the present invention is particularly useful the network is provided with a plurality of printers, which are managed by the print server. That is, the printer according to the present invention is presumed to be provided with the memories for storing therein the order sheet form or the like. Actually, there naturally exist printers without such memories. Even in such printers, the use of the print server according to the present invention enables the supplies to be ordered by e-mail according to the present invention.

In the print server according to the present invention, the e-mail address memory can store therein the e-mail address of the administrator of the printer. Consequently, the administrator of the printer can be free from work of creating the order sheet in ordering the supplies, as described in the printer according to the present invention. In addition, it is possible to make the order sheet on the basis of the order information and the order sheet form, and then, attach the order sheet to the e-mail document as an attached file, so that the administrator can pre-approve the ordering of the supplies. Furthermore, the order sheet can be printed out for an approval signature for the ordering, if a place for an approval signature is kept on the order sheet, the approval signature for the ordering can be obtained. The matters explained about the printer according to the present invention can be applied in principle to the print server according to the present invention. For example, the order sheet form stored in the order sheet form memory is not limited to one format, but may be a plurality of formats.

Embodiments according to the present invention will be described below with reference to the drawings.

Description of symbols used herein:

1a, 1b, 1c . . . Personal computer (PC)

2, 2a, 2b, 2c . . . Printer

3 . . . Facsimile apparatus

5 . . . Network

6 . . . Print server

21 . . . Printing engine

22, 62 . . . Collection information memory

23, 63 . . . Information judging unit

24, 64 . . . Order sheet creating unit

25, 65 . . . E-mail document creating unit

26, 66 . . . History manager

27, 67 . . . Outside communication interface

28 . . . Console panel

29, 69 . . . Event information memory

30, 70 . . . Order information memory

31, 71 . . . Form memory

32, 72 . . . E-mail address memory

73 . . . Display/keyboard

First Embodiment

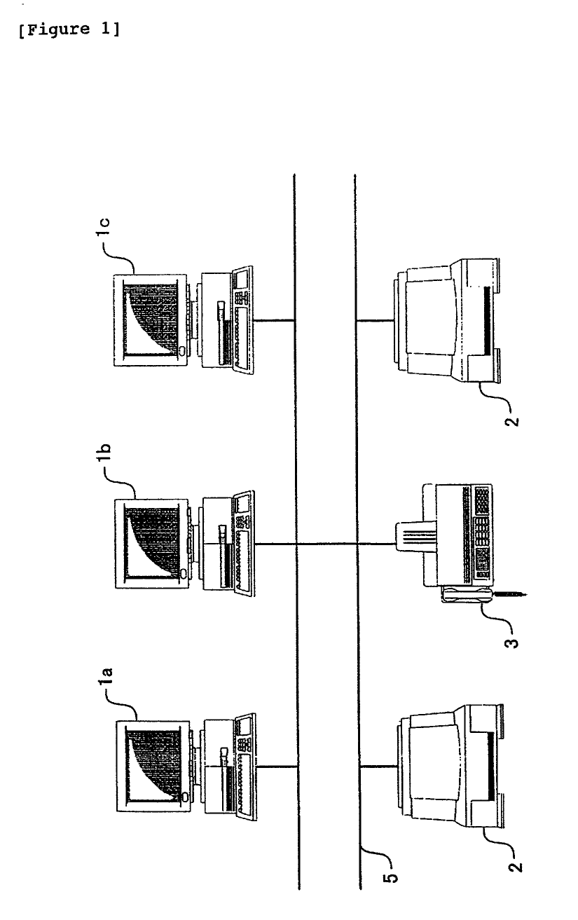

FIG. 1 is a view illustrating the configuration of a print system in a embodiment according to the present invention.

In FIG. 1, personal computers (hereinafter abbreviated to “PCs”) 1a, 1b, 1c, . . . are connected to printers 2 and a facsimile apparatus 3 as office equipment over a network 5. Out of the PCs 1a, 1b and 1c, the PC 1a is used by an administrator who administers the printer 2 over this network.

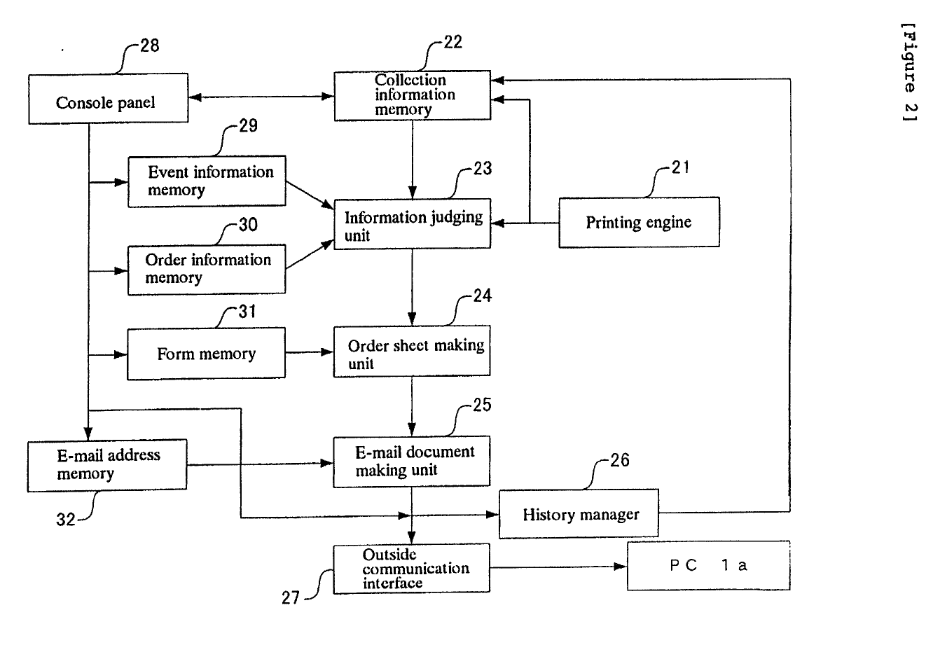

FIG. 2 is a block diagram illustrating the ordering supplies function in the printer 2. In FIG. 2, detail components for performing printing and its control will be omitted, and well-known component parts in the prior art can be assumed. As shown in FIG. 2, the printer 2 comprises a printing engine 21, a collection information memory 22, an information judging unit 23, an order sheet creating unit 24, an e-mail document creating unit 25, a history manager 26, an outside communication interface 27, a console panel 28, an event information memory 29, an order information memory 30, a form memory 31 and an e-mail address memory 32.

The printing engine 21 is an essential component part concerned in printing in the printer 2, and also is adapted to transmit event information such as the remainder or inventory of supplies and errors to the collection information memory 22 and the information judging unit 23. The supplies of the printer 2 include toner cartridges, printing paper, feed rolls for feeding paper inside the printer, or the like. There has been recently a printing apparatus added with the function of stapling sheets of printed paper. In such a printer, staples are included items in the supplies. The printing engine 21, the collection information memory 22 and the information judging unit 23 constitute a supplies sensing unit.

The collection information memory 22 stores therein the event information from the printing engine 21. The collection information memory 22 is provided with a supplies inventory table, described later, and updates the inventory information on the basis of the event information. This information is transmitted to the console panel 28 and the information judging unit 23.

As already described above, the remainder of the supplies signifies the quantity of the supplies held in the printer 2 per se: for example, the quantity of toner remaining inside a toner cartridge mounted on the printer 2, or the quantity of printing paper stacked in a paper tray in the printer 2. As for feed rolls, abrasion caused by friction with the printing paper must be taken into consideration. Such abrasion cannot signify the remainder in a strict sense. However, the remainder according to the present invention is defined to encompass the degree of such exhaustion. Such examples include developers, ink ribbons or the like in addition to the feed rolls. Well-known means in the prior art may be used in order to sense the remainder lifetime of the above-exemplified supplies.

Additionally, as already described above, the inventory of the supplies signifies the quantity (number) of supplies held in a place other than the printer 2. For example, if a user stocks two toner cartridges, the inventory of the toner cartridges is two. The same goes for the printing paper or the like. Since it is difficult to sense the inventory of the stored supplies by the printer 2 per se, for example, the administrator of the printer 2 can enter the inventory in the memory by means of inputting or the like via the console panel 28 in the printer 2 or keypad on a terminal.

The information judging unit 23 reads out the event information generated from the event information memory 29, and compares the inventory information transmitted from the collection information memory 22 with a lower limit of the inventory. When the inventory falls below the lower limit, issuance of an order sheet is required, from the order information memory 30. From the comparison result, if it is judged that the ordering is required, the order information is transmitted to the order sheet creating unit 24.

The order sheet creating unit 24 makes an order sheet by filling in the order information transmitted from the information judging unit 23 in appropriate blanks on the order sheet form read from the form memory 31.

For example, upon receipt of information instructing the ordering of a toner cartridge from the information judging unit 23, the order information relating to the toner cartridge stored in the order information memory 30 is read. In the meanwhile, the order sheet form is read from the form memory 31, and then, the order sheet is created by filling in the order information in the order sheet form. In the case where a plurality of formats of order sheet forms are stored in the form memory 31, the order sheet form to be used in ordering a toner cartridge is retrieved.

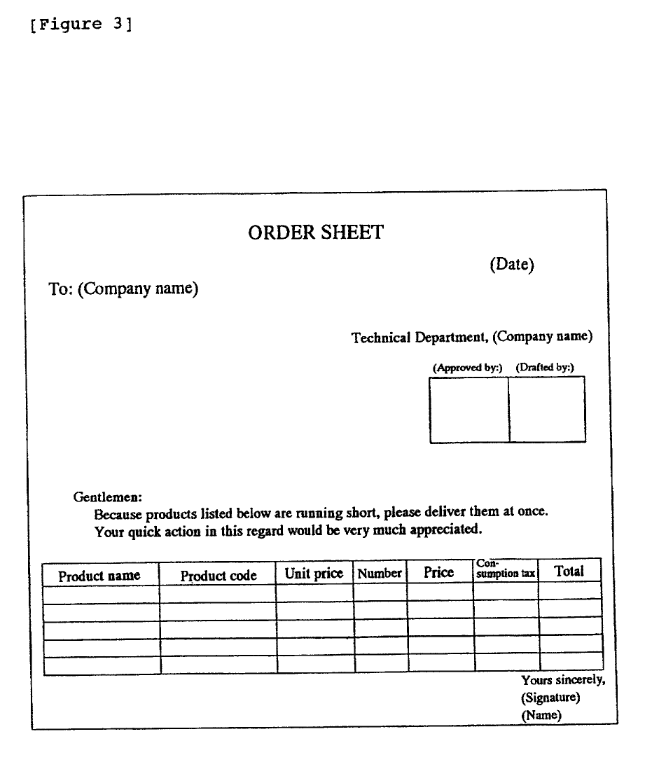

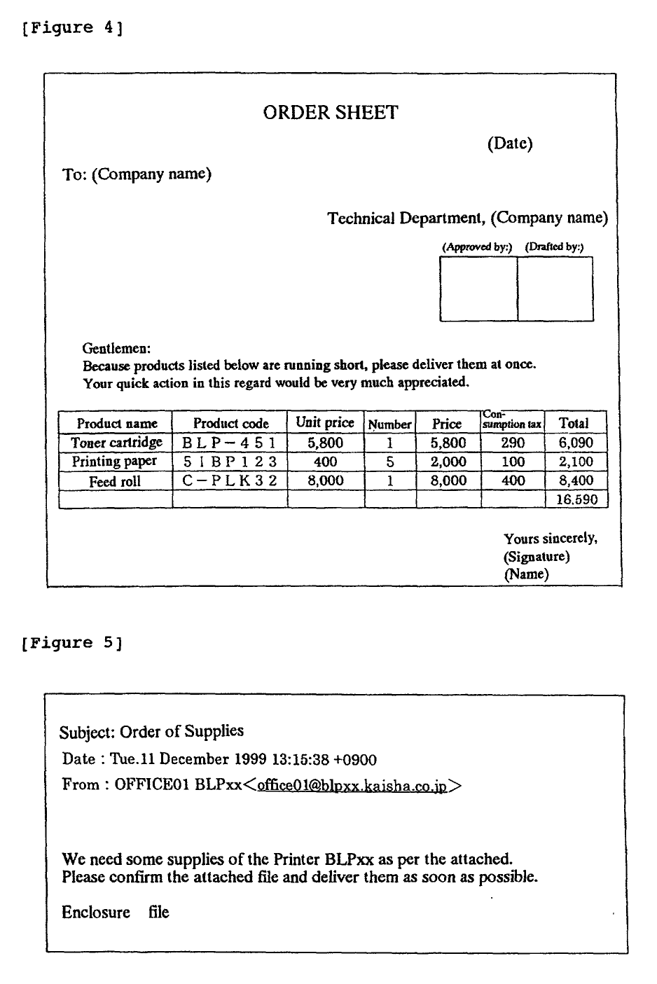

FIG. 4 illustrates one example of a filled-in order sheet. FIG. 3 illustrates a basic form of the order sheet. By way of this example, when the information judging unit 23 judges that toner cartridges, printing paper, feed rolls or the like need to be ordered, each order information is read from the order information memory 30 to be thus filled in the appropriate places on the order sheet form illustrated in FIG. 3. The filled-in order sheet is transferred to the e-mail document creating unit 25. The order sheet form illustrated in FIG. 3 will be explained later.

An e-mail document is created in the e-mail document creating unit 25, to which the order sheet transferred from the order sheet creating unit 24 is attached. The order sheet is attached as an attached file to the e-mail document which transmits the order. FIG. 5 illustrates one example of the e-mail document which transmits the order. As for the e-mail document, a document may be created in accordance with the contents of the order sheet, or a document may be selected from a plurality of formats of previously prepared samples.

The history manager 26 stores therein the order history and delivery history of the supplies. Specifically, the history manager 26 stores therein the ordered item, its order date, the delivered supplies and its delivery date in association with the order sheet. This history enables the order and delivery of the supplies to be managed. Furthermore, for example, unless the supplies have been delivered by a standard delivery date after the ordering of the supplies, the e-mail document creating unit 25 makes an e-mail document indicative of no delivery so that the history manager 26 can transmit the e-mail document to notify the administrator of the printer 2. The history manager 26 is provided with a table for storing therein the order history and a table for storing therein the delivery history, both of which will be described later.

The console panel 28 displays thereon the event information transmitted from the printing engine 21. In the case where the ordered supplies are delivered, the administrator of the printer 2 (or another person) inputs delivery information on the number of the order sheet, the product name, delivery date and number of the delivered items for example. This input of the delivery information results in updating the inventory of the supplies in the collection information memory 22 and the delivery date in the history manager 26.

The event information memory 29 stores therein the type of event information transmitted from the printing engine (21) and information on the order sheet form corresponding to the type of event information. Since the event information signifies the remainder or inventory of the supplies or errors, as described above, the event information memory 29 stores therein information on the order sheet form corresponding to the event information. Here, although no supplies can be ordered in case of an error, a form for notifying the error also is called an order sheet for the sake of convenience according to the present invention. The event information memory 29 is provided with an event information master, described later.

The order information memory 30 stores therein the quantity of each of supplies to be ordered once, that is, stores therein information, for example, three in case of the toner cartridges or five cartons in case of the printing paper. The order quantity is assumed to be dependent upon a user of the printer 2. Namely, in case of a user who consumes many pieces of printing paper, the order quantity is increased; in the case of a user who consumes a few pieces of printing paper, the order quantity is decreased. Consequently, the order information stored in the order information memory 30 is set and registered by the user of the printer 2. Furthermore, the order quantity can be automatically increased or decreased according to the using frequency of each of the supplies. For example, if the order quantity is set to three at the maximum and one at the minimum according to the using frequency, the order quantity can be varied within the setting range, for example, three in the case of the high using frequency, two in the case of the regular using frequency and one in the case of the low using frequency. The administrator of the printer 2 can set and register the order information by inputting on the console panel 28 of the printer 2. The order information includes the product code, unit price, order unit and price of the items in addition to the product name and order quantity of the items, which may be appropriately determined by the user. The order information memory 30 is provided with an order information master, described later.

The form memory 31 stores therein the form of the order sheet which is used in ordering the supplies. Each of the users has his or her own form of the order sheet, and therefore, the form memory 31 can store therein the form of the order sheet per user. FIG. 3 illustrates one example of the form of the order sheet. On the form of the order sheet, there are blanks in which the product name, product code, unit price, number, unit and price of the supply can be inserted. The order information stored in the order information memory 30 is provided in these blanks. Moreover, in the order sheet are written the ordering destination and the ordering user, under which there are blanks for a signature of a draftsman and an approver of the order sheet. Such a blank is unnecessary for a user not requiring any sealing in ordering.

The form of the order sheet stored is not limited to one kind. For example, at least two kinds of order sheet forms different in only ordering destination need be stored in the case where the ordering destinations of toner cartridges and printing paper are different. Otherwise, there may be stored a plurality of kinds of order sheet forms different in basic format.

Any form of the order sheet form may be stored in the form memory 31: in other words, any form of the order sheet form may be stored as long as the order information is fetched from the order information memory 30, and the order sheet filled in with the order information can be created. As one example, there may be used a method for storing the order sheet form as an overlay so as to fill the order information output from the order information memory 30 in the overlay. The form memory 31 is provided with a form master, described later.

The e-mail address memory 32 stores therein an e-mail address of the destination to which the e-mail document with the order sheet attached thereto created in the e-mail document creating unit 25 is transmitted. The e-mail addresses stored in the e-mail address memory 32 includes the e-mail address of the administrator of the printer 2. However, in the case where the order sheet need not be confirmed by the administrator but may be ordered as it is, it is sufficient to store only the e-mail address of the destination. The e-mail document with the order sheet attached thereto created in the e-mail document creating unit (25) is transmitted to the e-mail address via the outside communication interface 27. The destinations include the administrator of the printer 2, as described above. However, the destinations may include the ordering destination of the supplies or both of the administrator of the printer 2 and the ordering destination of the supplies. The e-mail address memory 32 is provided with an e-mail address master, described later.

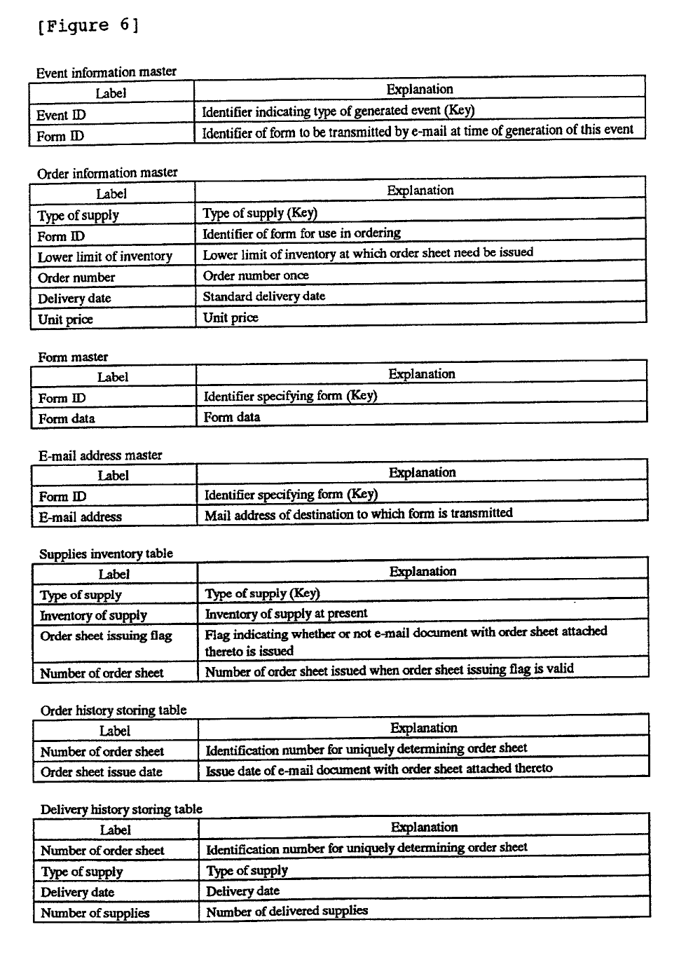

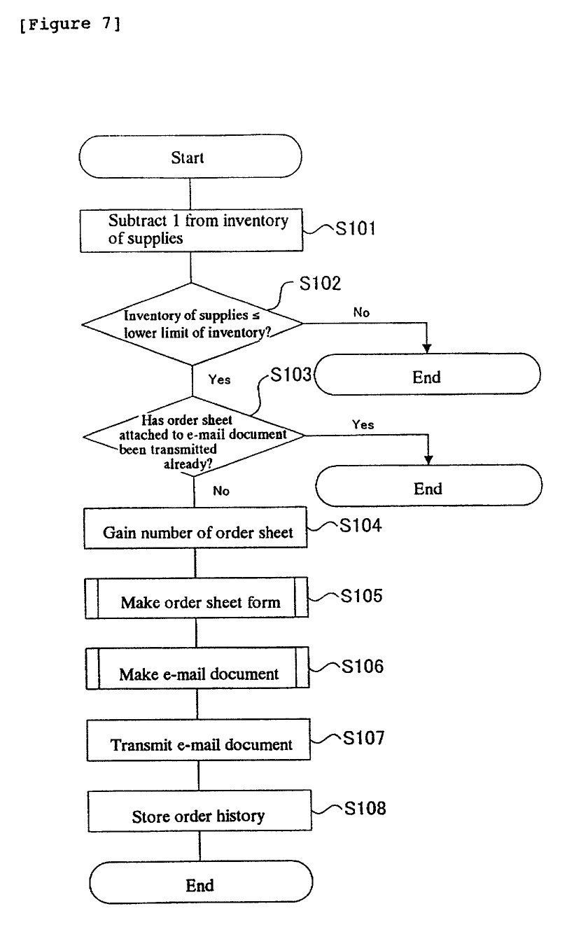

FIG. 6 illustrates the definitions of the tables provided in the collection information memory 22 or the like illustrated in FIG. 2. Referring to FIG. 6, explanation will be created of the contents of the event information master, the order information master, the form master, the e-mail address master, the supplies inventory table, the order history storing table and the delivery history storing table. These tables are merely examples, and should not limit the present invention.

The event information master has “an event ID” and “a form ID” as labels. “The event ID” is an identifier applied per type of event generated in the printer 2, and serves as a key in the event information master. “The form ID” is an identifier of the order sheet form to be sent by e-mail per type of event at the time of generation of the event.

The order information master has “the type of supply,” “a lower limit of inventory,” “the order number,” “an appointed date of delivery” and “a unit price” as labels. “The type of supply” signifies various supplies such as toner cartridges and printing paper used in the printer 2, and is a key in the order information master. “The lower limit of inventory” signifies a lower limit of the inventory which requires issuance of an order sheet, and the lower limit can be set by the user of the printer 2. For example, assuming that toner cartridges are to be ordered when the inventory becomes two, the lower limit of the inventory of toner cartridges is two. “The order number” signifies the number of supplies to be ordered. “The order number” can also be set by the user of the printer 2 in the same manner as the case of “the lower limit of the inventory.” For example, on the assumption that two toner cartridges are ordered at a time, “the order number” is two. “The appointed date of delivery” is a standard appointed date of delivery after the ordering of each of the supplies until the delivery. “The appointed date of delivery” is referred to by the administrator of the printer 2 in actually determining an order timing. “The unit price” is a price per supply, and is referred to by the administrator of the printer 2 and the approver of the ordering for confirmation of the ordering price in ordering.

Next, description will be given of the form master. The form master is present in the form memory 31, and has “a form ID” and “form data” as labels. “The form ID” is an identifier for specifying an order sheet form. In the case of a plurality of order sheet forms, “a form ID” is applied to each of the order sheet forms. Furthermore, “the form ID” specifies per order sheet form which order sheet form should be used. The necessity of the plurality of order sheet forms has been described above. “The form data” signifies data for creating an order sheet form. By specifying “the form ID,” the order sheet form is created based on the form data corresponding to the specified “form ID.”

The e-mail address master is present in the e-mail address memory 32, and has “a form ID” and “an e-mail address” as labels. “The form ID” is the same as that in the above-described form master. To “the e-mail address” is assigned an e-mail address of the destination to which the order sheet is delivered per “form ID,” i.e., per order sheet form.

Subsequently, the supplies inventory table is present in the collection information memory 21, and has “the type of supply,” “the inventory of supplies,” “an order sheet issuing flag” and “the number of an order sheet” as labels.

“The type of supply” is the same as that in the order information master. “The inventory of supplies” signifies the number of the inventory of supplies at present. It is judged whether the ordering is allowed or not based on the comparison of “the inventory of supplies” with the lower limit of the inventory in the order information master. “The order sheet issuing flag” is a flag indicating whether or not the e-mail document with the order sheet created in the order sheet creating unit 24 attached thereto is transmitted to the destined mail address via the outside communication interface 27. The flag is valid if the e-mail document has been transmitted already; on the contrary, the flag becomes invalid if the e-mail document has not been transmitted yet. “The number of an order sheet” is the number of the order sheet issued when the order sheet issuing flag is valid, i.e., the number of the order sheet put onto the order sheet transmitted already by e-mail.

Finally, explanation will be created of the order history storing table and the delivery history storing table. The order history storing table and the delivery history storing table are present in the history manager 26. The order history storing table has “the number of an order sheet” and “an issue date of an order sheet” as labels. “The number of an order sheet” is an identification number for uniquely identifying the order sheet created in the order sheet creating unit 24; and “the issue date of an order sheet” signifies the date when the e-mail document with the order sheet attached thereto is transmitted or issued.

The delivery history storing table has “the number of an order sheet,” “the type of supply,” “a delivery date” and “the number of supplies” as labels. “The number of an order sheet” is the same as that in the order history storing table; and “the type of supply” is the same as that in the order information master. In the delivery history storing table, “the number of the order sheet” and “the type of supply” are filled in as “the delivery date” remains blank at the time when the e-mail document with the order sheet attached thereto is created in the e-mail document creating unit 25. “The delivery date” is filled in after the actual delivery of the supplies. Although “the delivery date” is normally to be a date when the ordered supplies are delivered to the user of the printer 2, a date may be later than the actual delivery date since “the delivery date” is data input by the administrator. “The number of supplies” is the number of delivered items, and is input after the actual delivery.

As the above-described, hardware implementing the printer 2 may be well-known hardware. Namely, there may be provided a hard disk for storing therein information to be stored in each of the memories such as the form memory 31, memories for storing therein programs for executing the processes in the order sheet creating unit 24 and the e-mail document creating unit 25, and a CPU for interpreting the programs so as to execute the process in addition to basic hardware for controlling printing in the printer 2. Of course, there conventionally has existed a printer originally provided with the hard disk, the memories and the CPU, and therefore, such a printer may be used in that case.

Next, the order processing for the inventory of supplies will be described below in reference to a flowchart illustrated in FIG. 7. This flowchart is to be executed after replacement of the supplies of the printer 2.

First, in step 101 (hereinafter simply abbreviated to “s101”), the inventory of supplies is confirmed. Since the supplies have been just replaced by other supplies, a value obtained by subtracting 1 from the inventory of the supplies up to that time becomes the inventory at present. Subsequently, in S102, the inventory of the supplies is compared with the lower limit of the inventory stored in the order information master in the order information memory 30. If the inventory of the supplies is equal to or less than the lower limit of the inventory, it is judged that the supplies need be ordered, and then, the control routine proceeds to S103. If the inventory of the supplies is greater than the lower limit of the inventory, it is judged that the ordering of supplies has not been required yet, and then, the control routine comes to an end.

In S103, it is confirmed whether or not the order sheet issuing flag in the supplies inventory table relating to the supplies is valid, that is, whether or not the order sheet of the supplies has been transmitted already by e-mail. If the order sheet of the supplies has been transmitted already by e-mail, then the control routine comes to an end. However, if the order sheet issuing flag is invalid, the control routine proceeds to S104, in which case the number of the order sheet of the supplies is obtained.

After the number of the order sheet is obtained, the control routine proceeds to S105, in which the order sheet is created. The order sheet is created in the order sheet creating unit 24. Namely, while the order information on the supplies is read out of the information judging unit 23, the form data is read out of the form master in the form memory 31 by specifying the form ID. The order information is filled in appropriate blanks of the read form data, i.e., the order sheet form, thereby creating the order sheet.

After creating the order sheet, the e-mail document is created in S106. The e-mail document is created in the e-mail document creating unit 25, in which the order sheet is attached as an attached file to the e-mail document for advancing the ordering, thereby leading to completion of the e-mail document creating operation.

Upon completion of the e-mail document creating operation, an e-mail address corresponding to the form ID is read out of the e-mail address master present in the e-mail address memory 32 in S107, and then, transmission is performed. In this example, the e-mail document is transmitted to the address of the administrator of the printer 2.

After the transmission of the e-mail document, the order history is stored in S108. The order history is stored in the order history storing table present in the history manager 26 by inputting the number of the order sheet and the issue date of the order sheet. When the order history has been stored, a series of supplies ordering processes in the printer 2 is led to completion.

If the administrator of the printer 2 receives the e-mail document in his own PC 1a, he or she can confirm the e-mail document with the order sheet of the supplies attached thereto. The administrator prints out the e-mail document and the order sheet, puts his or her signature thereon, gets the ordering approver's signature thereon, and then, sends the order sheet to the ordering destination. Otherwise, without any necessity of an approval signature and with the applicability of the ordering destination to the e-mail, the administrator can send the order sheet to the ordering destination by e-mail.

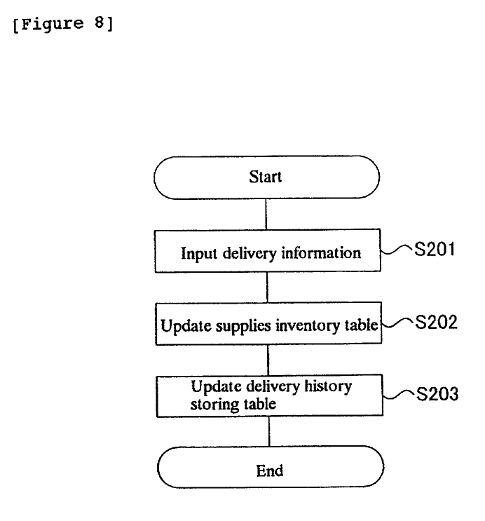

In the present embodiment, after the ordered supplies have been delivered, the information stored in the supplies inventory table in the printer 2 and the information stored in the delivery history table are updated. This series of processes will be described below in reference to a flowchart of FIG. 8.

As illustrated in FIG. 8, after the ordered supplies have been delivered, the delivery information on the supplies, specifically, the number of the order sheet of the supplies, the number of delivered supplies and the delivery date are input in S201. On the basis of this information, the type of delivered supply is specified based on the numbers of the order sheets in the order history storing table and delivery history storing table present in the history manager 26, and thereafter, the supplies and the number of delivered supplies are transmitted to the collection information memory 22, so that the inventory of the supplies in the supplies inventory table can be updated (in S202). For example, assuming that the inventory of the supplies before the delivery of the supplies is one and the number of delivered supplies is two, the inventory of the supplies is updated to three. Thereafter, it is judged whether or not the ordering is required based on the updated inventory of the supplies. Next, the delivery date in the delivery history storing table is updated in S203, thereby leading to completion of a series of processes.

In the printer 2 in the present embodiment, the predetermined order sheet forms have been previously stored in the form memory 31, and the order sheet is created by using the forms as well as the order information in the order information memory 30, thus obviating the necessity of creating the order sheet by the administrator of the printer 2. Furthermore, since the order sheet can be transmitted as the file attached to the e-mail document, the administrator of the printer 2 can confirm the contents of the order sheet to then formally perform the ordering if the administrator receives the e-mail document with the order sheet attached thereto. Additionally, if the order sheet is printed out, the administrator or the ordering approver can put his or her signature thereon.

Second Embodiment

In the first embodiment, the printer 2 stores therein the order sheet forms, and is provided with the function of creating the e-mail document. However, the present invention is not limited to the above-described embodiment. For example, as described below, the same function may be provided for a print server in a network provided with a plurality of printers.

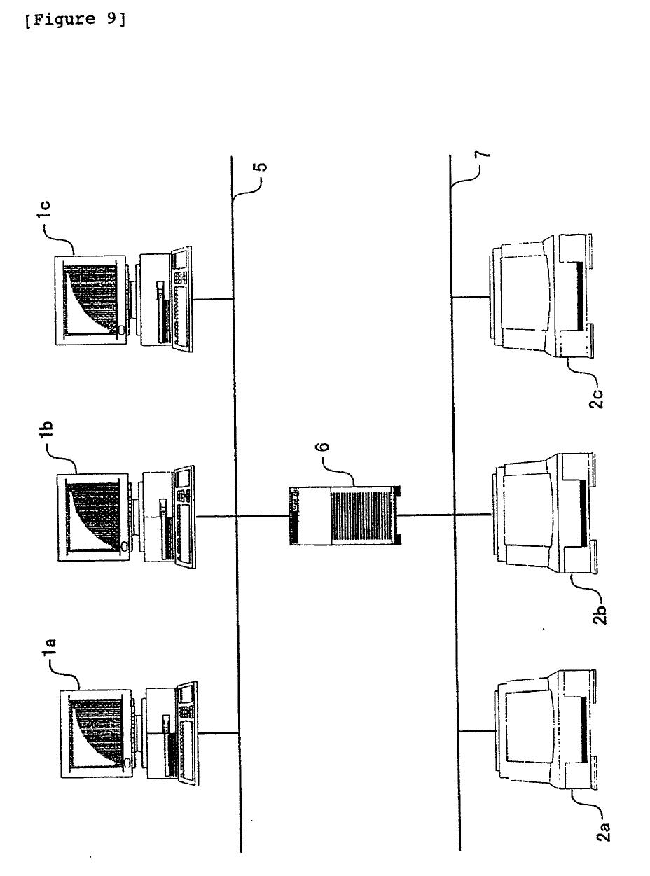

In FIG. 9, a print server 6 interconnected with PCs 1a, 1b, 1c, . . . and printers 2a, 2b, 2c, . . . as peripheral equipment. The PCs 1a, 1b, 1c, . . . are connected to the print server 6 over a network 5. Furthermore, the print server 6 is connected to the printers 2a, 2b, 2c, . . . via a bi-directional parallel interface, a serial interface (RS232, USB or the like) or another network 7 (hereinafter generally called “a network 7”). In addition to the printers 2a, 2b, 2c, . . . , another printing apparatus such as a facsimile apparatus 3 may be connected to the print server 6 over the network 7. PC 1a is used by an administrator for administering the printers 2a, 2b, 2c, . . . in the network.

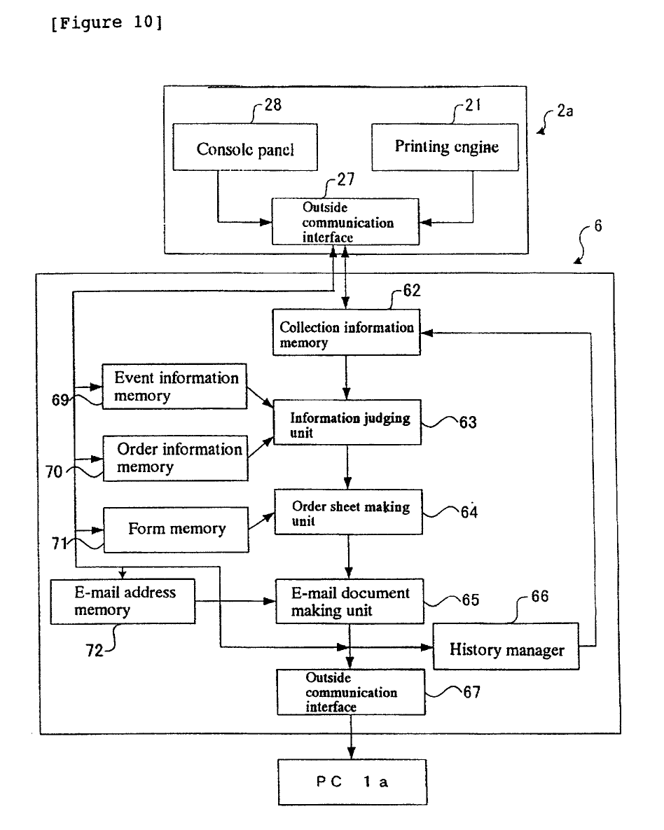

FIG. 10 is a block diagram illustrating the main functions of the printers 2a to 2c, and the print server 6. As illustrated in FIG. 10, the printers 2a to 2c, comprise a printing engine 21, an outside communication interface 27 and a console panel 28. On the other hand, the print server 6 comprises a collection information memory 62, an information judging unit 63, an order sheet creating unit 64, an e-mail document creating unit 65, a history manager 66, an outside communication interface 67, an event information memory 69, an order information memory 70, a form memory 71 and an e-mail address memory 72. The present embodiment is different from the first embodiment in that in the present second embodiment, the printer is equipped with all of the functions of creating the order sheet and the e-mail document.

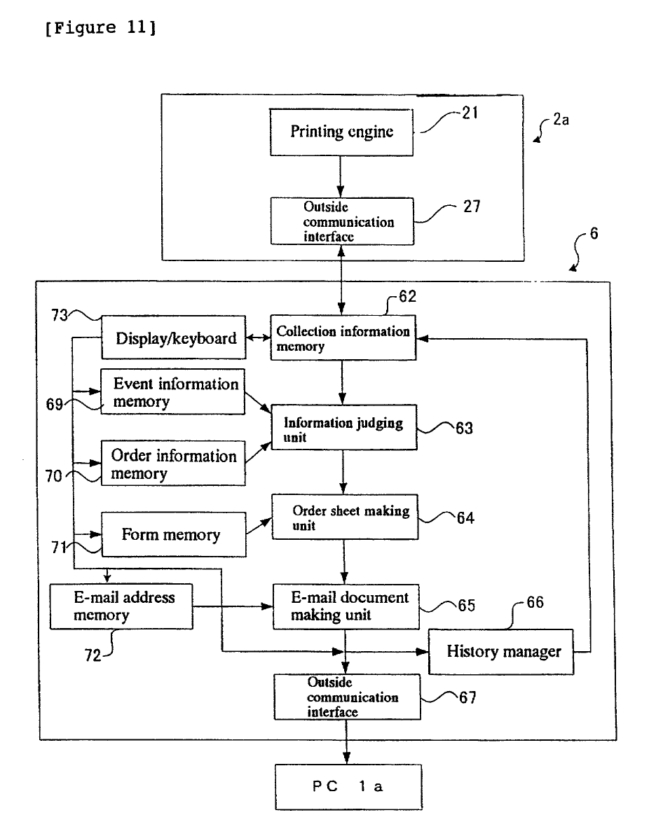

Moreover, FIG. 11 is a block diagram illustrating another example using a print server 6. A difference from the configuration illustrated in FIG. 10 resides in that printers 2a to 2c are not provided with any console panel 28 and the printer server 6 comprises a display/keyboard 73 as input means. That is, in the configuration illustrated in FIG. 10, the order information is registered on the console panel 28 of the printers 2a to 2c. In the configuration illustrated in FIG. 11, order information is registered via the display/keyboard 73 in the print server 6.

As described above, the embodiment in which the print server 6 is equipped with the functions of creating an order sheet and an e-mail document is advantageous as follows. In order to provide each of the printers with the functions of creating the order sheet and the e-mail document as in the first embodiment, each of the printers need be provided with hardware such as a calculator or a memory. In other words, since it is assumed that the printer is provided with such hardware in the above-described embodiment, inexpensive printers can hardly fulfill such functions. However, if the print server 6 is equipped with the functions of creating the order sheet and the e-mail document as illustrated in FIG. 10, the inexpensive printers also can produce the same advantages as those produced in the first embodiment. This results in cost reduction of the print system since each of the printers need not be equipped with the functions of creating the order sheet and the e-mail document.

Incidentally, the component elements of the printers 2a to 2c and print server 6 are similar to those in the above-described first embodiment, and therefore, their explanation will be omitted here.

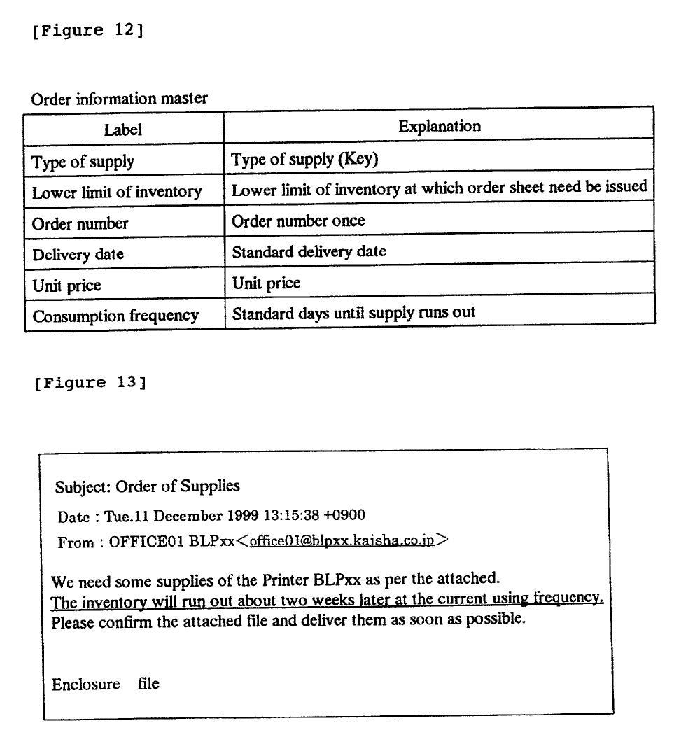

As illustrated in FIG. 12, the print server 6 in the present second embodiment is equipped with the function of predicting when supplies will run out by storing the consumption frequency of each of supplies in an order information master, and then, comparing the consumption frequency with the inventory of supplies stored in a supplies inventory table by the information judging unit 63.

The order information master illustrated in FIG. 12 stores therein the consumption frequency of each of the items. For example, if one toner cartridge runs out in about one week by a user, the consumption frequency of the toner cartridge is stored as one week. The consumption frequency is compared with the inventory of supplies in the supplies inventory table present in the collection information memory 62, whereby the time when the inventory will run out can be predicted. For example, if the inventory of the toner cartridges is two, the time when the inventory runs out can be predicted to be two weeks later. This comparison is performed by the information judging unit 62. The resultant information is reflected on the e-mail document. One example is illustrated in FIG. 13, in which the message “The inventory will run out about two weeks later at the current using frequency” is based on the timing predicted by the comparison between the consumption frequency and the inventory. This message contributes to the actual administration of the ordering timing of the toner cartridge by the administrator of the printers 2a to 2c.

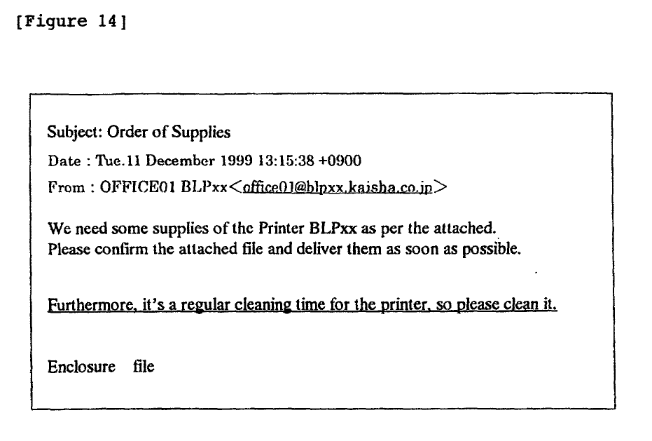

Additionally, although the information transmitting the order of the supplies is provided in the e-mail document in the above embodiments, information relating to the maintenance of the printers 2a to 2c may also be stated, for example, “Furthermore, it's a regular cleaning time for the printer, so please clean it,” as illustrated in FIG. 14.

As described above, the present invention can obviate the order sheet creating operation by the administrator of the printer in ordering the supplies. Moreover, the order sheet is created based on the order information and the order sheet form, and is attached to the e-mail document, so that the administrator of the printer can receive the e-mail document so as to previously confirm the ordering of the supplies. Furthermore, if the order sheet is printed out, the approval for the ordering can be obtained, and further, the approval signature can be got in the case where there is a blank for an approval signature.

While the embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for generating a purchase order for an item being depleted by a device comprising the steps of:
a) storing a predetermined low level value;
b) determining the amount of a depleting item that is in stock;
c) comparing the amount of the depleting item with the predetermined low level value;
d) creating a purchase order using a format preselected by a user if said comparing step indicates more of the item is needed; and
e) transmitting the purchase order to a predetermined location.

2. The method according to claim 1 further including the step of attaching said purchase order to an e-mail for transmission to said predetermined location.

3. The method according to claim 1 wherein said predetermined location is an approver's address.

4. The method according to claim 1 wherein said predetermined location is a supplier's address.

5. The method according to claim 1 wherein additional information is transmitted with the purchase order to a predetermined location.

6. The method according to claim 5 wherein said additional information includes a supplier's address.

7. The method according to claim 5 wherein said additional information includes an approver's address.

8. The method according to claim 5 wherein one of said additional information includes the address of the device that is originating the transmission of said purchase order.

9. The method according to claim 5 wherein said additional information includes status of the device.

10. The method according to claim 5 wherein said additional information includes information about the items being depleted.

11. The method according to claim 1 wherein said purchase order includes the name of an item to be ordered and the quantity to be ordered.

12. The method according to claim 1 wherein said purchase order is created using one of a plurality of purchase order form formats depending on which supplier is specified.

13. The method according to claim 1 wherein said purchase order is created using one of a plurality of purchase order form formats depending on a requester's design.

14. The method according to claim 1 wherein the device is one of a printer, a fax machine or a copier.

15. The method according to claim 1 wherein the purchase order is created and transmitted by the device.

16. The method according to claim 1 wherein the purchase order is created and transmitted by a computer attached to the device.

17. The method according to claim 1 wherein the purchase order is transmitted from the approver to the supplier.

18. The method according to claim 1 wherein the depleting item is comprised of discrete units that are processed by the device.

19. The method according to claim 1 wherein the depleting item is comprised of a wear out mechanism.

20. The method according to claim 1 wherein the depleting item is a time period.

21. The method according to claim 1 wherein the determining step includes sensing the amount of an item that is accessible by the device.

22. The method according to claim 1 wherein the determining step includes inventory in stock but not accessible by the device.

23. The method according to claim 1 further comprising the steps of:
f) calculating the consumption frequency of said depleting items;
g) comparing said consumption frequency with the inventory of items; and
h) predicting the time when the inventory in stock will be depleted.

24. The method according to claim 1 wherein the depleting item is time between scheduled service calls.

25. A system for generating a purchase order for an item being depleted by a device comprising:
a) means for storing a predetermined low level value;
b) means for determining the amount of a depleting item that is in stock;
c) means for comparing the amount of the depleting item with the predetermined low level value;
d) means for creating a purchase order using a format preselected by a user if said comparing step indicates more of the item is needed; and
e) means for transmitting the purchase order to a predetermined location.

26. The system according to claim 25 further including means for attaching said purchase order to an e-mail for transmission to said predetermined location.

27. The system according to claim 25 wherein said predetermined location is an approver's address.

28. The system according to claim 25 wherein said predetermined location is a supplier's address.

29. The system according to claim 25 wherein additional information is transmitted with the purchase order to a predetermined location.

30. The system according to claim 29 wherein said additional information includes a supplier's address.

32. The system according to claim 29 wherein said additional information includes an approver's address.

32. The system according to claim 29 wherein one of said additional information includes the address of the device that is originating the transmission of said purchase order.

33. The system according to claim 29 wherein said additional information includes status of the device.

34. The system according to claim 29 wherein said additional information includes information about the items being depleted.

35. The system according to claim 25 wherein said purchase order includes the name of an item to be ordered and the quantity to be ordered.

36. The system according to claim 25 wherein said purchase order is created using one of a plurality of purchase order form formats depending on which supplier is specified.

37. The system according to claim 25 wherein said purchase order is created using one of a plurality of purchase order form formats depending on a requester's design.

38. The system according to claim 25 wherein the device is one of a printer, a fax machine or a copier.

39. The system according to claim 25 wherein the purchase order is created and transmitted by the device.

40. The system according to claim 25 wherein the purchase order is created and transmitted by a computer attached to the device.

41. The system according to claim 25 wherein the purchase order is transmitted from the approver to the supplier.

42. The system according to claim 25 wherein the depleting item is comprised of discrete units that are processed by the device.

43. The system according to claim 25 wherein the depleting item is comprised of a wear out mechanism.

44. The system according to claim 25 wherein the depleting item is a time period.

45. The system according to claim 25 wherein the determining step includes sensing the amount of an item that is accessible by the device.

46. The system according to claim 25 wherein the determining step includes inventory in stock but not accessible by the device.

47. The system according to claim 25 further comprising the steps of:
f) calculating the consumption frequency of said depleting items;
g) comparing said consumption frequency with the inventory of items; and
h) predicting the time when the inventory in stock will be depleted.

48. The system according to claim 25 wherein the depleting item is time between scheduled service calls.

49. A computer program product comprising a computer useable medium having computer readable program code means therein for generating a purchase order for an item being depleted by a device said computer program product comprising:
a) computer readable program code means for storing a predetermined low level value;
b) computer readable program code means for determining the amount of a depleting item that is in stock;
c) computer readable program code means for comparing the amount of the depleting item with the predetermined low level value;
d) computer readable program code means for creating a purchase order using a format preselected by a user if said comparing step indicates more of the item is needed; and
e) computer readable program code means for transmitting the purchase order to a predetermined location.

50. The computer program product according to claim 49 further including computer readable program code means for attaching said purchase order to an e-mail for transmission to said predetermined location.

51. The computer program product according to claim 49 wherein said predetermined location is an approver's address.

52. The computer program product according to claim 49 wherein said predetermined location is a supplier's address.

53. The computer program product according to claim 49 wherein additional information is transmitted with the purchase order to a predetermined location.

54. The computer program product according to claim 53 wherein said additional information includes a supplier's address.

55. The computer program product according to claim 53 wherein said additional information includes an approver's address.

56. The computer program product according to claim 53 wherein one of said additional information includes the address of the device that is originating the transmission of said purchase order.

57. The computer program product according to claim 53 wherein said additional information includes status of the device.

58. The computer program product according to claim 53 wherein said additional information includes information about the items being depleted.

59. The computer program product according to claim 49 wherein said purchase order includes the name of an item to be ordered and the quantity to be ordered.

60. The computer program product according to claim 49 wherein said purchase order is created using one of a plurality of purchase order form formats depending on which supplier is specified.

61. The computer program product according to claim 49 wherein said purchase order is created using one of a plurality of purchase order form formats depending on a requester's design.

62. The computer program product according to claim 49 wherein the device is one of a printer, a fax machine or a copier.

63. The computer program product according to claim 49 wherein the purchase order is created and transmitted by the device.

64. The computer program product according to claim 49 wherein the purchase order is created and transmitted by a computer attached to the device.

65. The computer program product according to claim 49 wherein the purchase order is transmitted from the approver to the supplier.

66. The computer program product according to claim 49 wherein the depleting item is comprised of discrete units that are processed by the device.

67. The computer program product according to claim 49 wherein the depleting item is comprised of a wear out mechanism.

68. The computer program product according to claim 49 wherein the depleting item is a time period.

69. The computer program product according to claim 49 wherein the determining means includes sensing the amount of an item that is accessible by the device.

70. The computer program product according to claim 49 wherein the determining means includes inventory in stock but not age accessible by the device.

71. The computer program product according to claim 49 further comprising:
f) computer readable program code means for calculating the consumption frequency of said depleting items;
g) computer readable program code means comparing said consumption frequency with the inventory of items; and
h) computer readable program code means predicting the time when the inventory in stock will be depleted.

72. The computer program product according to claim 49 wherein the depleting item is time between scheduled service calls.
